(19) United States
(12) Patent Application Publication
(10) Pub. No.: US 2006/0027599 A1
(43) Pub. Date: Feb. 9, 2006

(54) Method and apparatus for dispensing compressed ice

(75) Inventors: William A. Edwards, Selma, TX (US); Randeep S. Grewal, San Antonio, TX (US); Michael J. Angelica, San Antonio, TX (US)

Correspondence Address: LAW OFFICES OF CHRISTOPHER L. MAKAY, 1634 Milam Building, 115 East Travis Street, San Antonio, TX, 78205, US

(73) Assignee: LANCER PARTNERSHIP, LTD.

(21) Appl. No.: 11/174,860

(22) Filed: Jul. 5, 2005

Related U.S. Application Data
(60) Provisional application No. 60/589,749, filed on Jul. 21, 2004.

(51) Int. Cl. B67D 5/56

(52) U.S. Cl. 222/129.1

(57) ABSTRACT

A compressed ice dispenser provides dispensing of both large and small quantities of compressed ice. The compressed ice dispenser includes a shroud having a storage chamber and a dispensing port, a paddlewheel having extended tangs disposed within the storage chamber, and an agitator bar assembly coupled to the paddlewheel, whereby compressed ice is delivered to the dispense port when the paddlewheel is rotated. The compressed ice dispenser further includes an ice chute assembly in communication with the dispensing port to deliver segmented portions of the compressed ice to a point of use. Further embodiments of the compressed ice dispenser include a shroud with a paddlewheel boss, and a solid paddlewheel. The compressed ice dispenser may further include at least one beverage dispensing circuit for the delivery of a beverage or concentrate, a cold plate with recharging capability, and a diluent delivery circuit for the delivery of a diluent for mixing.

### RELATED APPLICATION

The present application claims all available benefit, under 35 U.S.C. 119(e), of U.S. provisional patent application Ser. No. 60/589,749, filed Jul. 21, 2004. By this reference, the full disclosure of U.S. provisional patent application Ser. No. 60/589,749 is incorporated herein as though now set forth in its entirety.

### BACKGROUND OF THE INVENTION

1. Field of the Invention

The present invention relates to dispensing ice and, more particularly, but not by way of limitation, to methods and an apparatus for dispensing compressed ice.

2. Description of the Related Art

Beverage dispenser manufacturers have been managing the production and delivery of ice along with beverage drink for years. Consumers are now able to routinely dispense cubed ice at a beverage dispenser to chill a beverage. Icemakers are placed above beverage dispensers such that they drop ice into a storage chamber of the beverage dispenser. Stored ice is then transferred to a port for dispensing into a consumer's cup.

Consumers, however, prefer compressed ice over cubed ice. While compressed icemakers are available, management of compressed ice is more difficult than the management of cubed ice. Further, managing large quantities of compressed ice presents problems. Compressed ice is easily compacted, and compacted ice causes operational problems. Other issues include an increased melt rate when placed on a cold plate.

While existing compressed ice dispensers do exist, they tend to address only smaller storage capacities, and they are usually gravity feed. Compressed ice dispensers having large capacities do not currently exist.

Accordingly, an apparatus that can store large quantities of compressed ice while dispensing both small and large quantities of compressed ice would be beneficial to beverage dispenser manufacturers, as well as consumers.

### SUMMARY OF THE INVENTION

In accordance with the present invention, a compressed ice dispenser provides the ability to dispense both large and small quantities of compressed ice. The compressed ice dispenser includes a shroud including a storage chamber and a dispensing port, a paddlewheel having extended tangs disposed within the storage chamber, and an agitator bar assembly coupled to the paddlewheel, whereby compressed ice is delivered to the dispense port when the paddlewheel is rotated. The compressed ice dispenser further includes an ice chute assembly in communication with the dispensing port to deliver segmented portions of the compressed ice to a dispense point for use.

Further embodiments of the compressed ice dispenser include a shroud with a paddlewheel boss disposed beneath the paddlewheel to close out any hollow portions of the paddlewheel body, and a solid paddlewheel. In an alternative embodiment, the compressed ice dispenser includes at least one product dispensing circuit for the delivery of a product or product concentrate, a cold plate, and a recharging capability for the cold plate, thereby providing beverage drinks within acceptable temperature limits. Still further, the compressed ice dispenser may include a diluent delivery circuit for the delivery of a diluent for mixing with the product or concentrate.

It is therefore an object of the present invention to provide a compressed ice dispenser.

It is a further object of the present invention to store and dispense both large and small quantities of compressed ice from an ice dispenser.

It is still further an object of the present invention to provide an integrated beverage and compressed ice dispenser that dispenses beverage drinks within acceptable temperature limits, and compressed ice on demand.

Still other objects, features, and advantages of the present invention will become evident to those of ordinary skill in the art in light of the following. Also, it should be understood that the scope of this invention is intended to be broad, and any combination of any subset of the features, elements, or steps described herein is part of the intended scope of the invention.

### BRIEF DESCRIPTION OF THE DRAWINGS

FIG. 1 provides a perspective view of a compressed ice dispenser according to a first embodiment.

FIG. 1a provides a detailed view of the compressed ice dispenser according to the first embodiment.

FIG. 1b provides an exploded view of components required in a compressed ice dispenser according to the first embodiment.

FIG. 2 provides a perspective view of a shroud according to the first embodiment.

FIG. 2a provides a rear perspective view of the shroud according to the first embodiment.

FIG. 2b provides a cross section view of the shroud according to the first embodiment.

FIG. 3 provides a perspective view of an agitator motor assembly according to the first embodiment.

FIG. 4 provides a perspective view of a paddlewheel according to the first embodiment.

FIG. 4a provides a rear perspective view of a paddlewheel according to the first embodiment.

FIG. 5 provides a perspective view of an agitator bar assembly according to the first embodiment.

FIG. 6 provides a perspective view of a liner chute according to the first embodiment.

FIG. 6a provides an exploded view of an ice chute assembly according to the first embodiment.

FIG. 6b provides a cross-section view of the ice chute assembly according to the first embodiment.

FIG. 6c provides a method flowchart for using the compressed ice dispenser according to the first embodiment.

FIG. 7 provides section view of a shroud having a paddlewheel boss according to a second embodiment.

FIG. 7a provides a section view of a shroud utilizing a solid paddlewheel according to a third embodiment.

FIG. 8 provides a perspective view of an integrated beverage and compressed ice dispenser according to a second embodiment.

FIG. 8a provides a perspective view illustrating components utilized in the second embodiment.

FIG. 8b provides a cross section view of a second embodiment of the compressed ice dispenser.

FIG. 9 provides a perspective view of a shroud according to the second embodiment.

FIG. 9a provides a rear perspective view of the shroud according to the second embodiment.

### DETAILED DESCRIPTION OF THE PREFERRED EMBODIMENT

As required, detailed embodiments of the present invention are disclosed herein; however, it is to be understood that the disclosed embodiments are merely exemplary of the invention, which may be embodied in various forms. It is further to be understood that the figures are not necessarily to scale, and some features may be exaggerated to show details of particular components or steps.

In a first embodiment, a compressed ice dispenser provides the ability to deliver compressed ice on demand. The compressed ice dispenser includes a shroud, a paddlewheel, an agitator bar assembly, and an ice chute assembly that are conducive to the storage and delivery of large quantities of compressed ice. The compressed ice dispenser delivers a predetermined quantity of ice from an interior chamber within the shroud, through the ice chute assembly, and into a consumer's cup. The compressed ice dispenser configuration creates the ability to store the compressed ice for extended periods without bridging or packing to the point that compressed ice cannot be delivered. In a second embodiment, the compressed ice dispenser is integrated into a beverage dispenser. The second embodiment is similar to the first embodiment, however, the second embodiment provides for continued cold plate cooling and proper drink temperature.

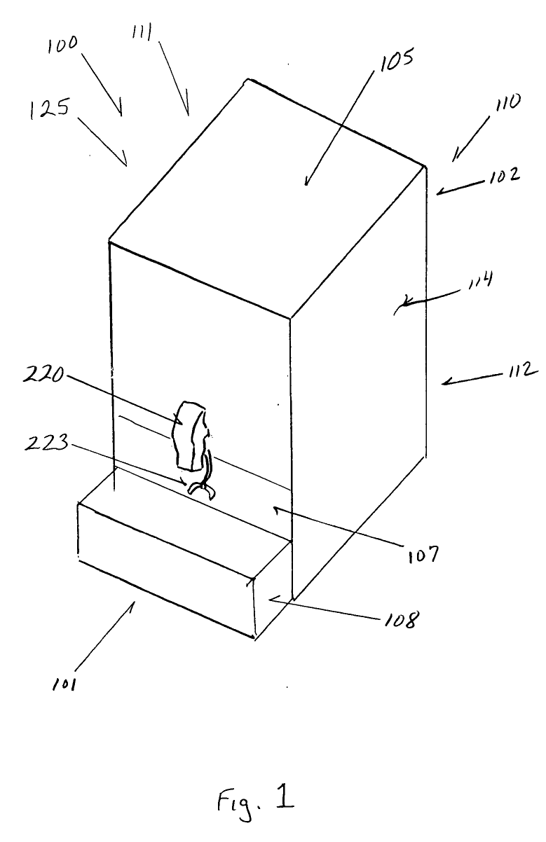

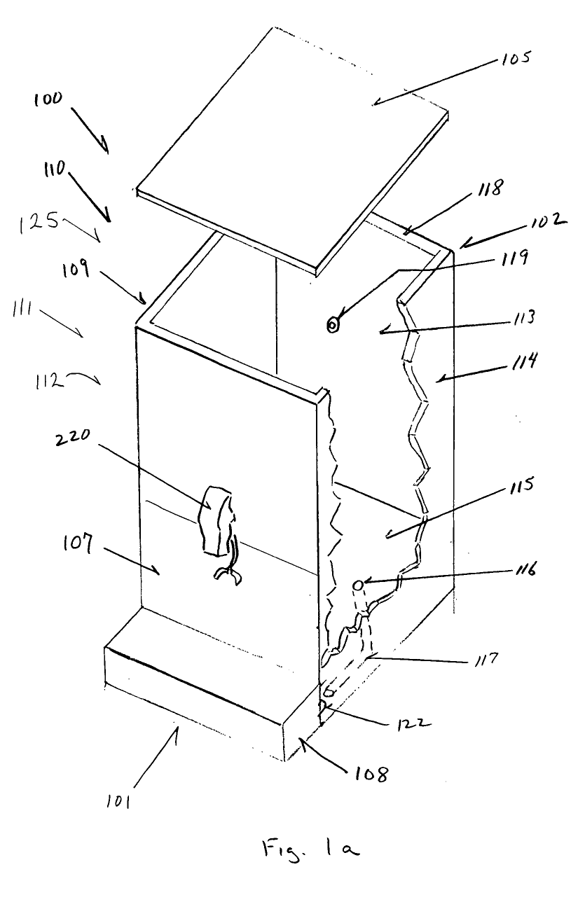

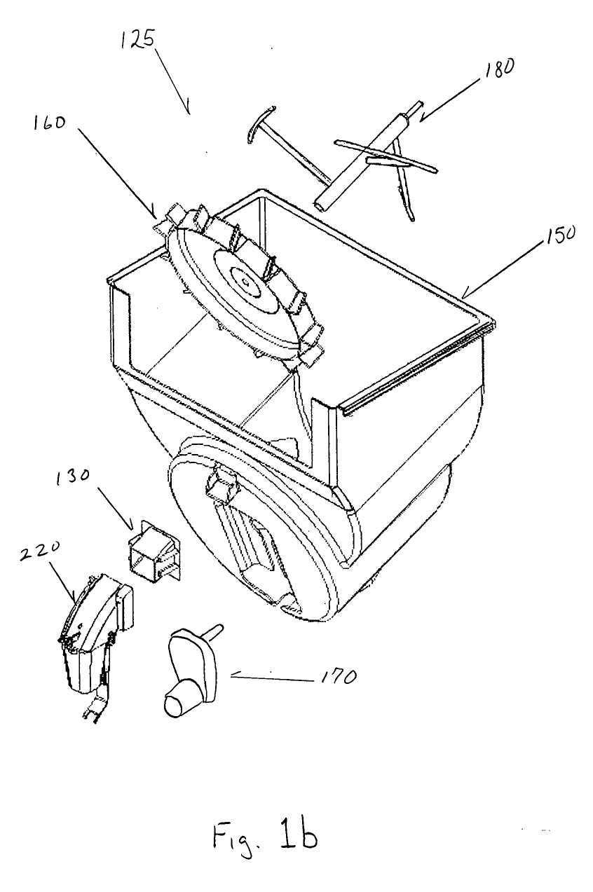

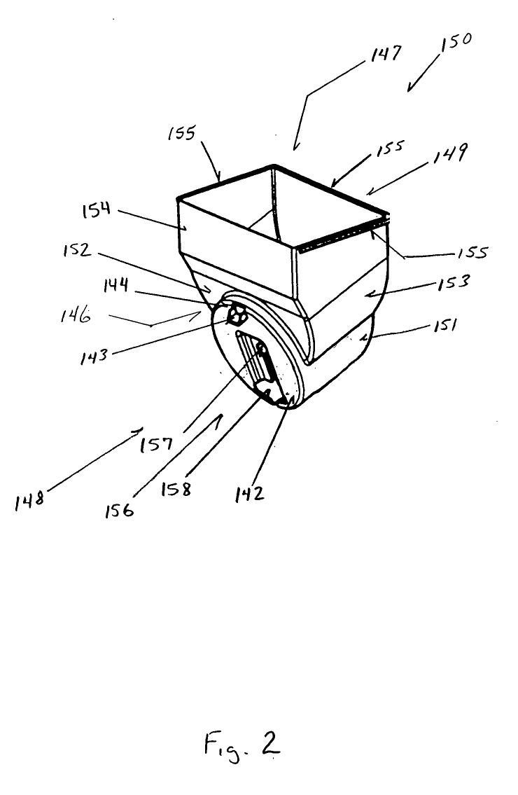

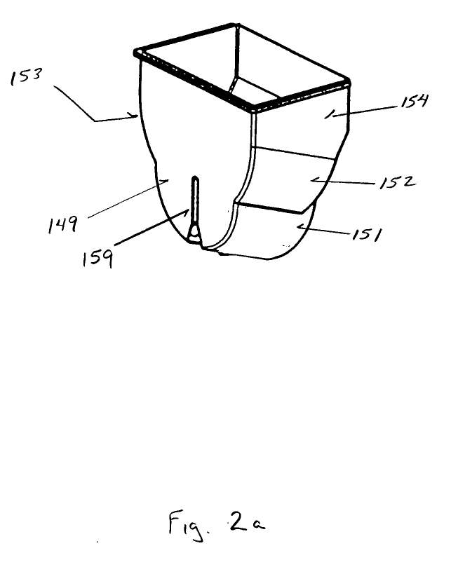

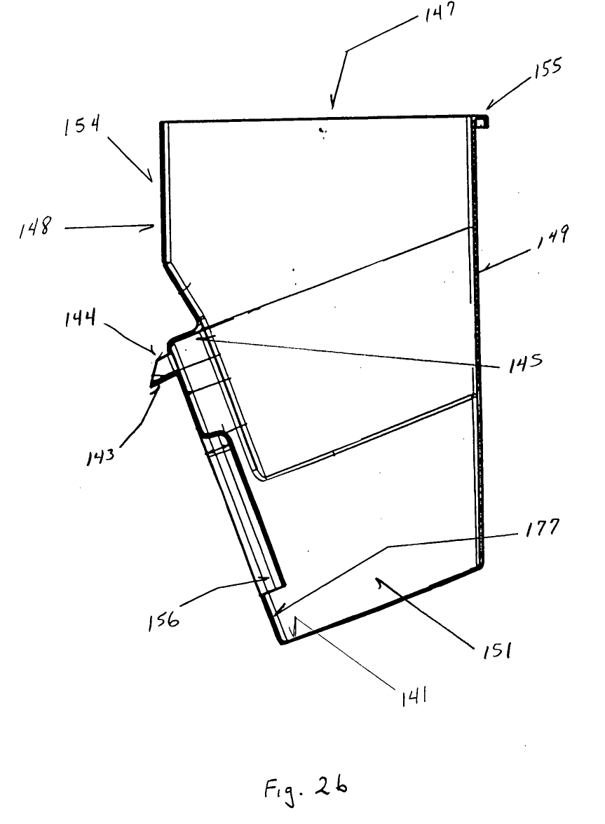

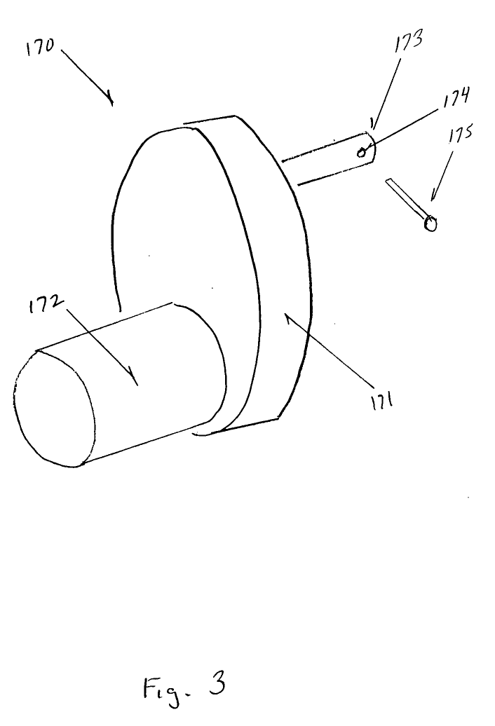

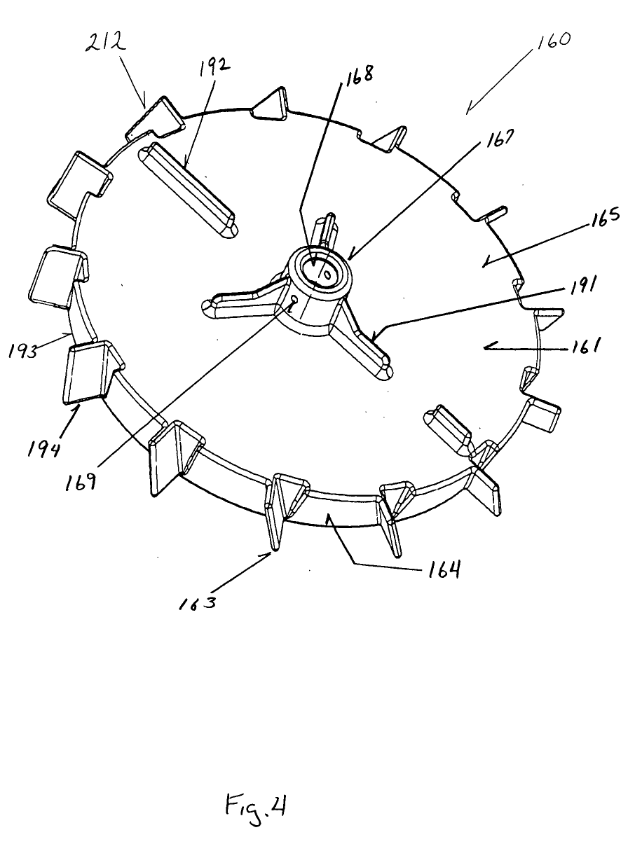

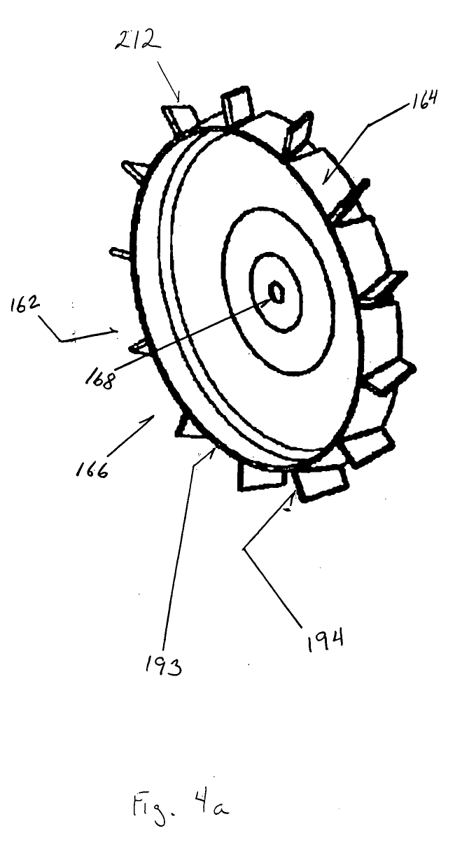

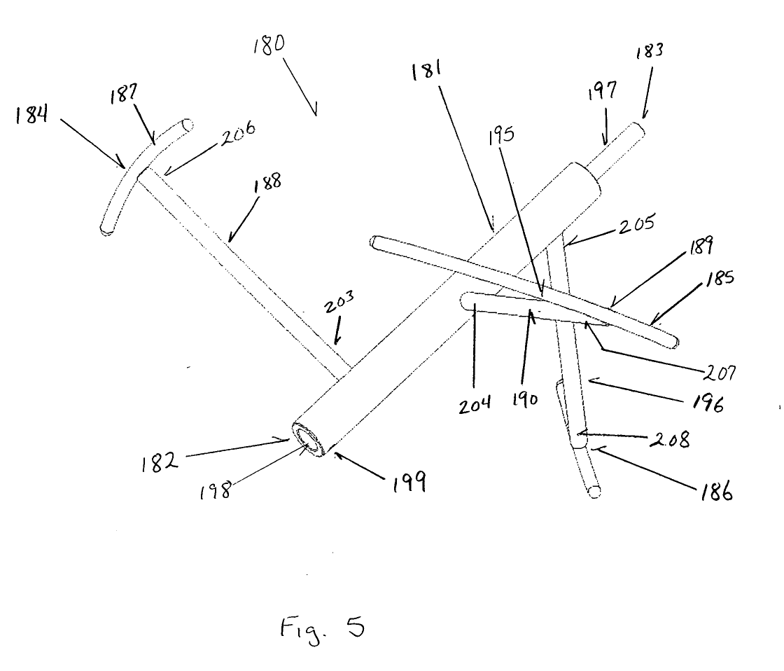

As shown in FIGS. 1-7, a compressed ice dispenser 100 includes a housing 110 and an ice dispensing circuit 125. The housing 110 includes a bin assembly 109, a wrapper 114, a splash plate 107, a drip tray 108, and a lid 105. The bin assembly 109, in this first embodiment is a stainless steel bin having four walls 113 and a bottom 115. The bin assembly 109 includes a frame assembly 112, a drain 116, an interior cavity 111, and a bushing 119. The drain 116 is located in the bottom panel 115, such that water in the interior cavity 111 may drain from the interior cavity 111 through a drain tube 117 to an inlet 122 of the drip tray 108. While this embodiment is shown with a drain tube 117 coupled to an inlet 122 of the drip tray 108, one of ordinary skill in the art will recognize that the drain tube 117 may be coupled to any suitable disposal apparatus, including sewer lines, storage tanks, and the like. The bushing 119 is foamed in place to provide load bearing capacity, and a consistent location. The lid 105 may be insulated to thermally isolate the interior cavity 111 from the surrounding environment, as well as any machinery in the general area of the interior cavity, including ice makers placed on top of the housing 110.

A foam 118 is molded around the bin assembly 109 to provide rigidity, insulative properties, and strength to support closeout panels and loads due to stored product. The wrapper 114 fits around the foamed bin assembly 109 to closeout the housing 110, and protect interior components of the compressed ice dispenser 100. The wrapper 114 is constructed from formed sheet metal, and may be removed from the bin assembly 109 for access during service calls. The drip tray 108 is mounted to the lower portion of a front 101 of the ice dispenser 100. The drip tray 108 is removable for cleaning. The inlet 122 of the drip tray 108 accepts fluids from the drain tube 117 for disposal. The splash plate 107 is a formed sheet metal component, and closes out the front 101 of the ice dispenser 100 above the drip tray 108, such that fluids or product falling onto the splash plate 107 will move toward the drip tray 108 due to gravitational forces. The splash plate 107 is removable for access to interior components. The lid 105 spans an upper end 102 of the frame assembly 112, thereby closing out the housing 110. The lid 105 is removable for access into the housing 110.

The ice dispensing circuit 125 includes a shroud 150, a paddlewheel 160, an agitator motor assembly 170, an agitator bar assembly 180, a liner chute 130, and an ice chute assembly 220. In this preferred embodiment, the shroud 150 is molded in polyethylene for reduced friction coefficients. The shroud 150 is removable from the housing 110 for cleaning, and includes a front 148, a rear face 149, and a storage chamber 147. The shroud 150 further includes rectangular section 154, a transition section 146, and a cylindrical section 151 passing from the front 148 to the rear face 149. The rectangular section 154 includes a lip 155 on three sides. The lip 155 is designed to fit over the upper end 102 of the housing 110, such that the shroud 150 is repeatedly locatable upon insertion into the housing 110. The transition section 146 allows product to move from the rectangular section 154 to the cylindrical section 151. The transition section 146 includes a first transition arc 152 and a second transition arc 153. The cylindrical section 151 is the lowest portion of the shroud 150, and is angled between the range of zero degrees and forty degrees. Preferably, the lower portion of the shroud 150 is at an angle of twenty degrees, such that the cylindrical section 151 is higher at the rear 149. The first and second transition arcs 152 and 153, respectively, are located above the cylindrical section 151, such that product located within the rectangular section 154 falls downward and through the transition arcs 152 and 153 to move toward and enter the cylindrical section 151.

The cylindrical section 151 protrudes from the front 148 of the transition section 146 to create a cylindrical inset 145 within the storage chamber 147. A cylindrical face 142 on the protrusion includes a dispensing port 144 and a recessed pocket 156. The cylindrical inset 145 includes an inner face 177 and an inner perimeter 141. The recessed pocket 156 includes an agitator motor shaft aperture 157 connected to a shaft relief 158. The shaft relief 158 provides a cutout, such that the shroud 150 may be pulled upward without requiring the removal of an agitator motor assembly 170 that is mounted within the recessed pocket 156. The dispensing port 144 provides access from the storage chamber 147 to the environment exterior to the storage chamber 147. The dispensing port 144 includes a chute 143 to guide product being removed from the storage chamber 147 through the dispensing port 144.

The rear face 149 of the shroud 150 includes a rear relief 159 that extends from a lowest point on the rear face 149 to a point slightly above the height of the bushing 119 that is mounted to the housing 110. The rear relief 159 provides clearance for the bushing 119 when removing the shroud 150 from the interior cavity 111 of the ice dispenser 100.

The agitator motor assembly 170 includes a gear box 171 with an electric motor 172. The agitator motor assembly 170 includes an output shaft 173, whereby torque is transmitted to components connected to the output shaft 173. In this first embodiment, the shaft 173 includes an aperture 174 for accepting a pin 175. The electric motor 172 may be any suitable form of torque transmission, including alternating current, direct current, and the like. The gear box 171 is any suitable form of revolution quantity reduction or increase device for achieving a desired output torque with a specific input torque. While this embodiment has been shown with a pin 175 and an aperture 174 for receiving the pin 175, it should be clear to one of ordinary skill in the art that the agitator motor assembly may be coupled to other components such as a paddlewheel and an agitator bar assembly using any means suitable for coupling components, including a spline, fasteners, mechanical linkages, or the like.

The paddle wheel 160 includes a body 161 in the shape of a truncated cone with a hollow top 162. The body 161 includes a first side 165 and a second side 166. The body 161 further includes a protrusion 167 having a central aperture 168, and tangs 163 disposed along an outer periphery 164. The protrusion 167 further includes a pin aperture 169 passing through the protrusion 167, and gussets 191 disposed around the protrusion 167. The first side 165 further includes risers 192 that extend radial to the axis of the cone.

The second side 166 of the paddle wheel 160 includes a leading edge 193 of the body 161 and a leading edge 194 of the tangs 163. In this first embodiment, the tangs 163 extend from the first side 165 to the leading edge 193 of the body 161. The tangs 163 are oriented at an angle of approximately twenty-five degrees from the axial direction. The tangs 163 further include peripheral leading edges 212 disposed at the outermost ends of the tangs 163. While this embodiment has been shown with the leading edges 194 of the tangs 163 extending to the leading edges 193 of the body 161, alternative embodiments may include paddlewheels having leading edges 194 at any distance up to one half of an inch from the leading edges 193 of the body 161.

The agitator bar assembly 180 includes a shaft 181 having a first end 182 and a second end 183, a first agitator 184, a second agitator 185, and a third agitator 186. The shaft 181 is cylindrical in shape, and preferably constructed from stainless steel. The first end 182 of the shaft 181 includes a pin aperture 199, and a clearance aperture 198. The clearance aperture 198 is located on an axis of the cylindrical shape, and is of a size and depth suitable for sliding over the output shaft 173 of the agitator motor assembly 170. The pin aperture 199 passes radially through the shaft 181, including the pin aperture 199. The pin aperture 199 is of a size suitable for accepting the pin 175. The second end 183 of the shaft 181 includes a reduced diameter 197, the diameter 197 being of a size suitable for engaging the bushing 119 disposed within the housing 110.

The first agitator 184 includes a first leg 188 and a first shoe 187. The second agitator 185 includes a second leg 190 and a second shoe 189. The third agitator 186 includes a third leg 196 and a third shoe 195. A first end 203, 204, and 205 of each leg 188, 190 and 196, respectively, is attached to the shaft 181. The legs 188, 190, and 196 may be attached to the shaft using any suitable means, preferably welding. The legs 188, 190, and 196 are disposed around the shaft 181 at substantially equivalent spacing, illustratively one hundred and twenty degrees. The first leg 188 and the second leg 190 extend radially from the shaft 181. The third leg 196 extends from the shaft 181 at an angle of approximately fifteen degrees from the plane that lies perpendicular to the shaft 181. The shoes 187, 189, and 195 are coupled to a second end 206, 207, and 208 of each respective leg 188, 190, and 196. The shoes 187, 189, and 195 are disposed at an angle of approximately thirty-two degrees from the plane perpendicular to the axis of the shaft 181. Once configured, the shoes 187, 189, and 195 form a helical shape to sweep substantially all of an inner surface of the cylindrical section 151 of the shroud 150 when the agitator bar assembly 180 is rotated. One of ordinary skill in the art will recognize that the lengths of the shoes 187, 189, and 195 and the legs 188, 190, and 196, as well as the length of the shaft 181 may vary to accommodate different products, different product particulate sizes, as well as varying bin sizes.

The liner chute 130 is an injection-molded component having a first end 133 and a second end 134, preferably molded in polyethylene for reduced friction coefficients. The first end 133 includes a flange 132. The flange 132 is coupled to a rectangular section known as a chute 131. The chute 131 intersects the flange 132 at an angle of approximately twenty-five degrees. The liner chute 130 further includes a passage 136 passing through the chute 131 and the flange 132. The liner chute 130 still further includes bosses 137 disposed next to the chute 131 for mounting. The bosses 137 include mounting apertures 138.

The ice chute assembly 220 includes an upper ice chute 221, a lower ice chute 222, an activator 223, a chute door 224, a door lever 225, a switch 226, and a spring 227. The upper ice chute 221 is an injection-molded component having a first end 228 and a second end 229. The upper ice chute 221 includes a passage 230 passing from an inlet 232 at the first end 228 to an outlet 233 at the second end 229. The passage 230 includes a floor 231 and a ceiling 268. The floor 231 and the ceiling 268 are formed in the shape of arcs. The arc shape is continuous from the inlet 232 to the outlet 233. While the arcs that form the ceiling 268 and floor 231 profiles are consistent, it should be clear to one of ordinary skill in the art that the arc diameters may vary to accommodate various particulate sizes of product, as well as varying distances of travel. The inlet 232 of the upper ice chute 221 is complementary to the shape of the second end 134 of the liner chute 130. The upper ice chute 221 further includes a mounting tab 234 on each side for attaching the upper ice chute 221 to the housing 110. The mounting tabs 234 include mounting apertures 235 for accepting mounting hardware.

The upper ice chute 221 further includes hinge points 237 near the second end 229 on each side, a spring mount 238, and a switch mount 236. The hinge points 237 may be any form suitable for creating a structural attachment point for other components, including molded in place features, snaps, screws, and the like. The hinge points 237 protrude from the sides of the upper ice chute 221. The spring mount 238 protrudes from an outer surface of the ceiling 268 nearest the second end 229 of the upper ice chute 221. The spring mount 238 includes an aperture 239 for connecting an end of the spring 227. The spring mount 238 further serves as a stop for the lower ice chute 222. The switch mount 236 may be any form suitable for creating an attachment point for the switch 226, including bosses, ledges, or mounting holes.

The chute door 224 is complementary in shape to the first end 228 of the upper ice chute 221. The chute door 224 is mounted within the confines of the inlet 232 using any suitable hardware that allows the chute door 224 to rotate about upper pivot points 240. In this embodiment, the upper pivot points 240 are shafts 241 that protrude from the chute door 224. The door lever 225 includes a cylindrical section 244 and an arm 242. The arm 242 is coupled to the cylindrical section 244 in a position parallel to the axis of the cylindrical section 244. The chute door 224 and the door lever 225 are injection-molded components, preferably of food grade plastics.

The lower ice chute 222 is disposed beneath the upper ice chute 221, and includes a first end 245 and a second end 246. The first end 245 includes an inlet 251, an outlet 252, and a passage 247 therethrough. The inlet 251 of the lower ice chute 222 is complementary in shape to the outlet 233 of the upper ice chute 221. The passage 247 includes a floor 254 and an opposing wall 255. The floor 254 is contoured in the shape of an arc. In this embodiment, the floor 231 of the upper ice chute 221 and the floor 254 of the lower ice chute 222 are of a same radius and arc center. When located adjacent to each other, the floors 231 and 254 form one continuous arc. The remaining walls of the passage 247 in the lower ice chute 222 taper from the first end 245 to the second end 246. The lower ice chute 222 further includes a spring mount 249, a plunger 250, and a lever mount 253. In this first embodiment, the spring mount 249 is molded into the lower ice chute 222, and may be any feature suitable for connecting an end of a spring, for example a tab with a hole. The plunger 250 is a boss located near the first end 245 of the lower ice chute 222. The plunger 250 is directed parallel to the passage 247, such that it lies substantially even with the first end 245 of the lower ice chute 222. The lever mount 253 is any feature suitable for mating with the activator 223, for example a molded in snap, screws, or a glue joint.

In this embodiment, the activator 223 is a lever, however, one of ordinary skill in the art will recognize that the activator 223 may be any form of user interface, including lever, electronic pushbuttons, or the like, to allow an operator to convey a signal to the dispenser 100. The activator 223 includes a body 259 having a first end 257 and a second end 258. The body 259 includes a chute mount 263 and mounts 262. The chute mount 263 is any suitable means for connecting the activator 223 to the lower ice chute 222, including screws, snap features, and the like. The mounts 262 are features integral to the lower ice chute 222. In this first embodiment, the mounts 262 extend from the first end 257 of the body 259. The second end 258 of the body 259 includes a lever arm 260. The lever arm 260 includes a cross bar 264 and a bottom support 261.

On assembly, an end of the drain tube 117 is attached to the drain 116 located in the bottom 115 of the interior cavity 111. The agitator motor assembly 170 is then attached to the housing 110, such that the output shaft 173 protrudes into the interior chamber 111 of the housing 110. Once the agitator motor assembly 170 is installed, the cylindrical section 145 of the shroud 150 is inserted into the interior chamber 111 with the front 148 of the shroud 150 aligned with the front 101 of the housing 110. The shroud 150 is inserted until the lip 155 rests on the upper end 102 of the housing 110. As the shroud 150 slides downward, the shaft relief 158 passes over the output shaft 173, and the rear cutout 159 passes over the bushing 119. In the installed position, the agitator motor shaft aperture 157 is aligned with the output shaft 173 of the agitator motor assembly 170, and the bushing 119 resides at an uppermost portion of the rear cutout 159. Further, the dispensing port 144 is aligned with a clearance passage through the front 101 of the compressed ice dispenser 100. In this position, the dispensing port 144 and the chutes 143 are accessible from the front 101 of the compressed ice dispenser 100.

Next, the liner chute 130 is attached around the dispensing port 144 and the chutes 143, such that the flange 132 of the liner chute 130 is pressed against the shroud 150, and the second end 134 is lower than the first end 133. The liner chute 130 is attached to the shroud 150 using any suitable means, including screws, glue, and the like.

Upon further assembly, the chute door 224 is installed into the first end 228 of the upper ice chute 221, and secured using fasteners 218. The door lever 225 is then placed onto the pivot shaft 241, such that the arm 242 is angled in general alignment with the second end 229 of the upper ice chute 221. Fasteners 219 are then placed onto the shaft to restrain the door lever 225 in place. Once assembled, the chute door 224 is able to rotate about the shafts 241, thereby providing a closing and opening action within the confines of the passage 230. Next, the switch 226 is installed in the switch mount 236, such that the plunger 250 faces downward. The switch 226 is restrained with a screw 243.

Assembly of the ice cute assembly 220 continues with the installation of the activator 223 onto the lower ice chute 222. The chute mount 263 of the activator 223 is attached to the lever mount 253 of the lower ice chute 222. The inlet 251 of the lower ice chute 222 is placed over the outlet 233 of the upper ice chute 221, such that the mounts 262 align with the hinge points 237 of the upper ice chute 221, and the spring mount 249 of the lower ice chute 222 aligns with the spring mount 238 of the upper ice chute 221. Upon installation, the lower ice chute 221 is free to rotate about the hinge points 237. Attachment of the lower ice chute 222 to the upper ice chute 221 is followed by the installation of the spring 227 onto the spring mounts 238 and 249. Upon assembly, the position of the lower ice chute 222 is biased to butt against the upper ice chute 221; however, the lower ice chute 222 and activator 223 may rotate together about the hinge points 237. The ice chute assembly 220 is then placed over the liner chute 130, and secured to the compressed ice dispenser 100, such that the activator 223 is positioned downward. Mounting apertures 235 located within the mounting tabs 234 of the upper ice chute 221 are aligned with the mounting apertures 138 of the liner chute 130, and are secured using screws 271.

The paddlewheel 160 is then inserted into the cylindrical inset 145 of the shroud 150, such that the central aperture 168 is placed over the output shaft 173 and the leading edges 193 and 194 of the paddlewheel 160 is nearest the inner face 177 of the shroud 150, and the peripheral leading edges 212 of the tangs 163 are adjacent to the inner perimeter 141 of the cylindrical inset 145. The paddlewheel 160 must then be rotated to align the pin aperture 169 with the aperture 174 of the output shaft 173.

The agitator bar assembly 180 may then be inserted into the chamber 147 of the shroud 150, such that the second end 183 is nearest the bushing 119 located in the housing 110. The second end 183 of the agitator bar assembly 183 may then be inserted through the bushing 119 to provide clearance for aligning the clearance hole 198 located on the first end 182 of the agitator bar shaft 181 over the output shaft 173 of the agitator motor assembly 170. Once aligned, the agitator bar assembly 180 slides over the output shaft 173, thereby supporting both ends 182 and 183 of the agitator bar assembly 180. Once supported, the pin aperture 199 must be aligned with the aperture 174 of the output shaft 173, and the pin aperture 169 of the paddlewheel 160. Once aligned, the pin 175 is placed through the apertures 199, 174, and 169 to restrain the paddlewheel 160 and the agitator bar assembly 180. In the pinned position, the paddlewheel 160 and the agitator bar assembly 180 are forced to move with the output shaft 173 to break up and dispense compressed ice when the output shaft 173 is rotated.

Upon assembly of the interior components, the lid 105 may be installed. Further, the drip tray 108 may be installed. The inlet 122 of the drip tray 108 is then connected to the second end of the drain tube 117, such that fluids flowing through the drain tube 117 gravitate to the drip tray 108 from the interior cavity 111. As previously disclosed, the drain tube 117 may be coupled to any suitable disposal system, where provisions for the attachment exist. The splash plate 107 is then installed onto the front 101 of the compressed ice dispenser 100 over the drip tray 108, thereby protecting interior components from errant dispenses.

In operation, storage quantities of compressed ice are delivered to the chamber 147 located in the shroud 150. The delivery of the compressed ice may be accomplished manually or through the use of an automatic icemaker disposed above the compressed ice dispenser 100, such that compressed ice enters the storage chamber 147 as it exits the icemaker. In such cases, the lid 105 may be reduced to a closeout panel. The compressed ice is stored within the storage chamber 147 until segmented by the tangs 163 and moved to the dispensing port 144 when the paddlewheel 160 is rotated.

Compressed ice enters the storage chamber 147 through the rectangular section 154. The rectangular section 154 substantially lines the interior cavity 111 of the housing 110, thereby maximizing a cross sectional inlet area. In an empty or near empty storage chamber 147, entering compressed ice falls through the rectangular section 154 to the first and second intermediate transition arcs 152 and 153. The transition arcs 152 and 153 collect the compressed ice entering above each of the transition arcs 152 and 153, and move it toward the cylindrical section 151 as it continues its downward descent. Compressed ice entering directly above the cylindrical section 151 may fall directly into the cylindrical section 151. At that point, the shoes 187, 189, and 195 are located within one inch of the inner surface of the cylindrical section 151. As such smaller quantities of compressed ice move into the cylindrical section 151 where the agitator bar assembly 180 is able to agitate the stored smaller quantity until being dispensed by the paddlewheel 160.

As larger quantities of compressed ice are stored, the storage chamber 147 begins to fill, and the compressed ice that enters the storage chamber 147 is stored in the rectangular section 154 until a majority of the stored ice is dispensed or melts. As the compressed ice is dispensed, the agitator bar assembly 180 rotates to sweep substantially an entire inner surface of the cylindrical section 151, thereby disrupting the equilibrium state of the ice and forcing the ice to reset. As the compressed ice resets, it moves downward along the angled cylindrical section 151 toward the paddlewheel 160. The agitator bar assembly 180 further agitates the stored ice located above the agitator bar assembly 180 to break up ice bridges that may form. Accordingly, the contoured storage chamber 147 coupled with the sweeping agitator bar assembly 180 is able to manage small and large quantities of compressed ice for dispensing.

Activating the activator 223 activates the switch 226, and provides power to the agitator motor 172, thereby rotating the output shaft 173. Rotation of the output shaft 173 causes the rotation of the components secured to the output shaft 173, including the paddlewheel 160 and the agitator bar assembly 180. Rotation of the agitator bar assembly 180 about the agitator shaft 181 forces the agitators 184, 185, and 186 to pass over an inner surface of the cylindrical section 151 of the shroud 150 at a prescribed distance, substantially within the range of zero to one inches, thereby directly agitating the ice located within the paths of the agitators 184, 185, and 186, and indirectly agitating the compressed ice located above the agitated areas. The agitated ice gravitates toward the bottom of the shroud 150 and further moves forward due to the slope of the cylindrical section 151.

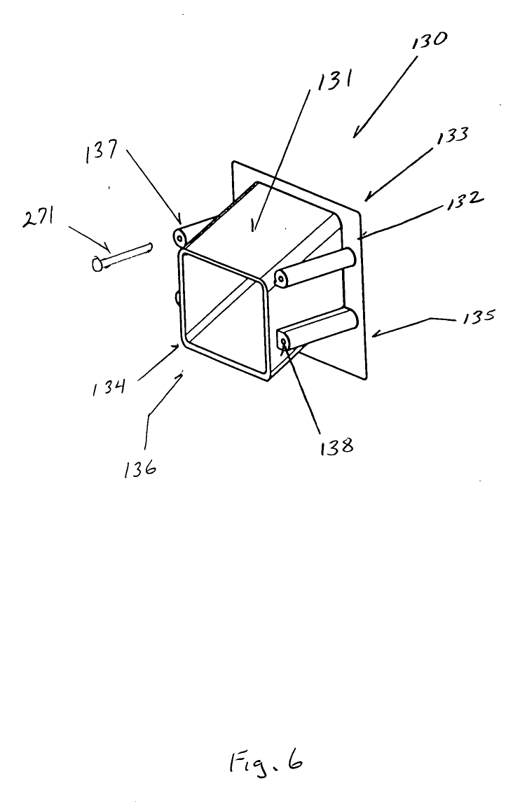

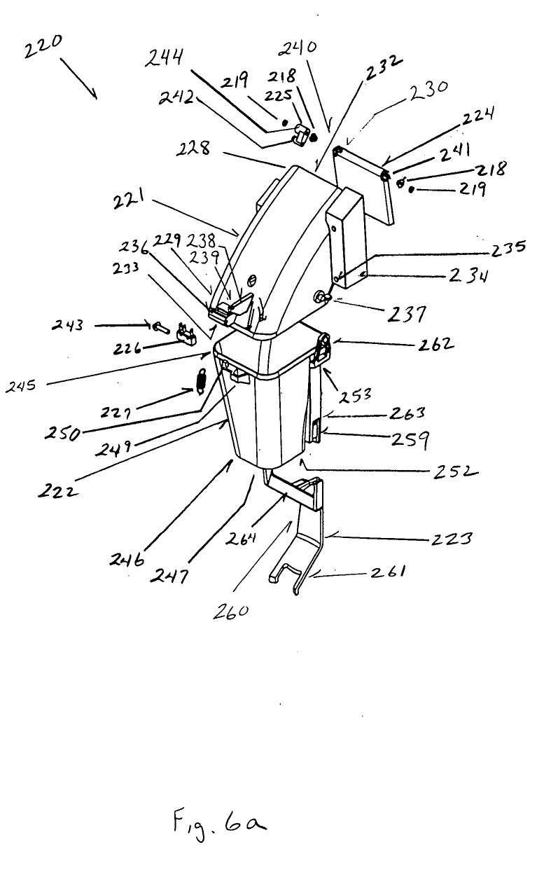

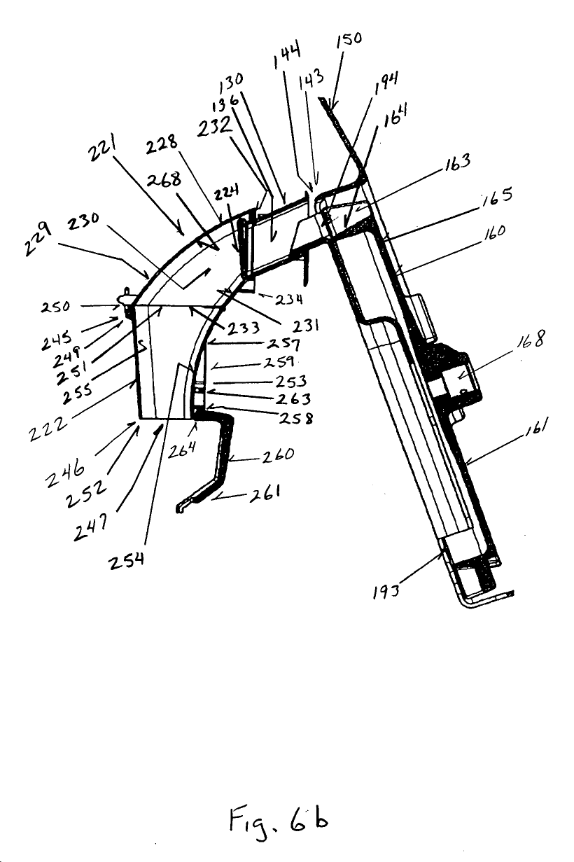

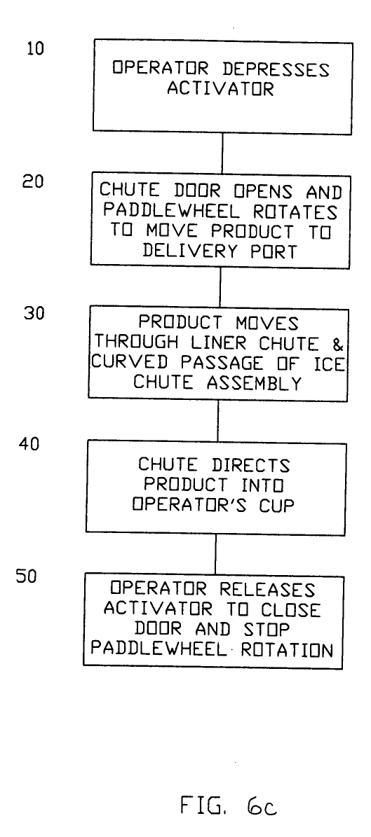

As ice approaches the cylindrical face 142 of the shroud 150, it comes to rest between the tangs 163 of the paddlewheel 160. In this embodiment, as shown in FIG. 6b, the tangs 163 of the paddlewheel 160 extend from a leading edge 193 of the body 161 to the first side 165, such that the tangs 163 are able to hold and move the compressed ice particles associated with the dispensing of compressed ice. Further, the peripheral edges 212 of the tangs 163 are disposed within the range of zero to one half of an inch to contain compressed ice particles. The paddlewheel 160 is then able to move the compressed ice to the dispensing port 144 when rotated by the output shaft 173 of the agitator motor 172.

The paddlewheel 160, the shroud 150, the liner chute 130, and the ice chute assembly 220 work in conjunction to deliver compressed ice from the paddlewheel 160 to the outlet 252. Compressed ice reaching the dispensing port 144 falls away from the paddlewheel 160 and through the dispensing port 144 due to the conical shape of the of the body 161. The conical shape of the body 161 in combination with the angle of orientation of the paddlewheel 160 in the installed position leads to an angled descent for the compressed ice to be dispensed. The dosage of compressed ice falls from the outer periphery 164 of the paddlewheel 160, and onto the chute 143 of the shroud 150. The dosage of compressed ice then moves through the passage 136 of the liner chute 130.

As the passage 136 of the liner chute 130 tapers away from the dispensing port 144, the compressed ice falls through the passage 136, thereby entering the ice chute assembly 220. The chute door 224 is open during paddlewheel 160 rotation to allow the passage of compressed ice through the liner chute 130 and directly into the passage 230 of the upper ice chute 221. The radial floor 231 located within the passage 230 provides an increasing vertical gravitational force component as the compressed ice moves along the floor. The increasing vertical gravitational component in combination with an increased cross sectional area of the second end 229 of the upper ice chute 221 minimizes the possibility of ice compacting within the passage 230.

As the compressed ice exits the upper ice chute 221 substantially unobstructed, it enters the passage 247 of the lower ice chute 222. The compressed ice continues to gain an increasing vertical gravitational component as the floor 254 of the lower ice chute 222 follows the radial path of the floor 231 of the upper ice chute 221. As the compressed ice reaches the second end 246 of the lower ice chute 222, the gravitational forces on the compressed ice are substantially vertical, and the compressed ice is unable to pack in the second end 246 of the lower ice chute 222. The compressed ice then exits the lower ice chute 222 to be dispensed. In this first embodiment, compressed ice passing through the chute door 224 is dispensed, such that no compressed ice remains within the passages 230 and 247 of the ice chute assembly 220 between dispenses.

Closing of the switch 226 terminates the delivery of power to the agitator motor 172. In this first embodiment, the switch 226 is activated and deactivated by depressing the activator 223. Releasing the activator 223 forces the chute door 224 to close, thereby eliminating any errant deliveries of compressed ice.

In use, an operator depresses the dispensing activator 223 with a cup, as shown in step 10 of the method flowchart provided in FIG. 6c. Depressing the dispensing activator 223 forces the chute door 224 open, and activates the switch 226 to provide electrical power to the agitator motor 172, thereby forcing the rotation of the output shaft 173, the paddlewheel 160, and the agitator bar assembly 180, as shown in step 20. The process continues with step 30, wherein the paddlewheel 160 segments and moves the compressed ice to the dispensing port 144 for delivery through the passage 136 of the liner chute 130, and the passages 230 and 247 of the ice chute assembly 220. The compressed ice moves through the ice chute assembly 220, and is dispensed into the operator's cup, step 40. The process continues with the operator releasing the activator 223 when a desired amount of the compressed ice is delivered, step 50. The releasing of the activator 223 terminates the delivery of power to the agitator motor 172, thereby ceasing the rotation of the output shaft 173 and the connected components.

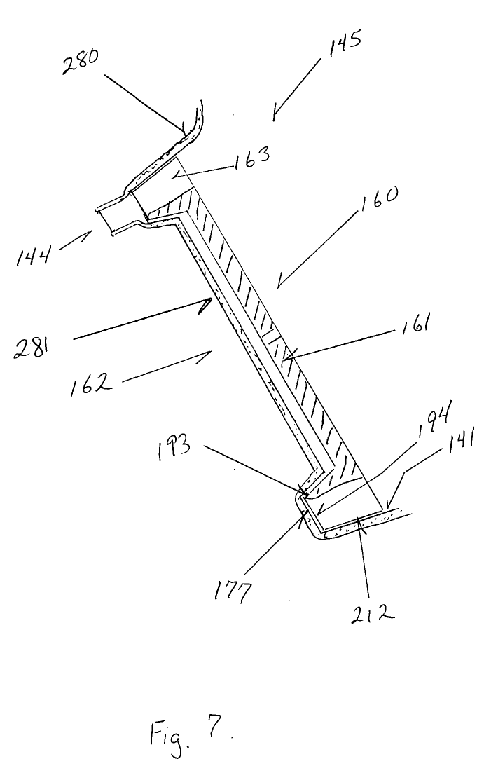

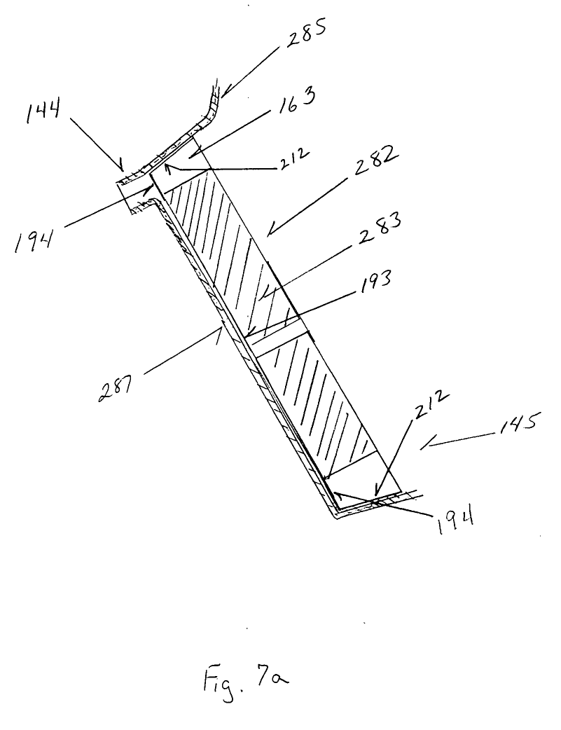

In a second embodiment, a compressed ice dispenser is substantially identical to the first embodiment, and like parts have been numbers with like numerals. In this second embodiment, however, a shroud 150 is replaced with a shroud 280. As shown in FIG. 7, the shroud 280 includes a cylindrical inset 145 and a paddlewheel boss 281. A paddlewheel 160 identical to the first embodiment is disposed within the cylindrical inset 145 such that the leading edges 193 and 194 are adjacent to an inner face 177 of the cylindrical inset 145, and the paddlewheel boss 281 fits into the hollow top 162 of the paddlewheel body 161. The paddlewheel 160 mounts identically as the first embodiment, and operates in an identical fashion to move compressed ice to a dispensing port 144 disposed in the cylindrical inset 145. All other relationships between the leading edges 193, 194, and 212 of the paddlewheel 160, and the inner perimeter 141 and the inner face 177 of the shroud 280 are identical to the first embodiment in form and function.

In use, the paddlewheel 160 rotates with the agitator motor shaft 173. The paddlewheel boss 281 extends into the hollow top 162, thereby reducing the possibility of errant ice particles packing within the hollow top 162 or beneath the body 161 of the paddlewheel 160. The size of the paddlewheel boss 281 should be of a diameter that allows the paddlewheel 160 to spin freely, yet not have a large gap between the inner portion of the hollow top 162 and the exterior diameter of the paddlewheel boss 281. Illustratively, the gap should be within the range from minimal clearance up to one half of a diameter of a typical ice particle to be dispensed, or approximately one hundred and fifty thousandths of an inch.

Alternatively, the compressed ice dispenser of this second embodiment may be modified to substitute a paddlewheel 282 having a solid body 283, and a shroud 285 having a substantially flat inner face 287 for the paddlewheel 160 and the shroud 280. In this third embodiment as shown in FIG. 7a, the shroud 285 includes a cylindrical inset 145 having a dispense port 144. The paddlewheel 282 is located within the cylindrical inset 145 such that the leading edges 193 and 194 of the paddlewheel 282 are nearest the inner face 287. In this arrangement, the solid body 283 of the paddlewheel 282 prevents ice particles from becoming lodged between the solid body 283 and the inner face 287. All other operations, relationships, and functions are identical to the first embodiment, wherein the paddlewheel 282 rotates to capture compressed ice between the tangs 163 and deliver compressed ice to the dispense port 144 in the shroud 285 for use.

In a fourth embodiment, a compressed ice dispenser as disclosed in the first embodiment is combined with a beverage dispensing system to form an integrated dispenser 300. The integrated dispenser 300 includes most components from the first embodiment. Accordingly, like parts have been numbered with like numerals. The integrated dispenser 300 includes all required hardware to deliver compressed ice and beverages to consumers, as well as provisions for ensuring the delivery of beverages within prescribed temperature thresholds. One of ordinary skill in the art will recognize that beverage dispensers are well known in the art, particularly post-mix beverage dispensers.

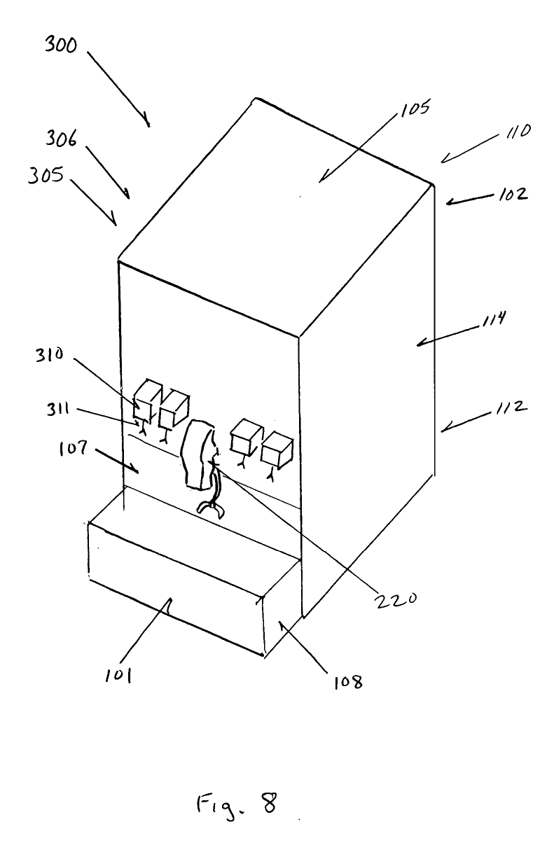

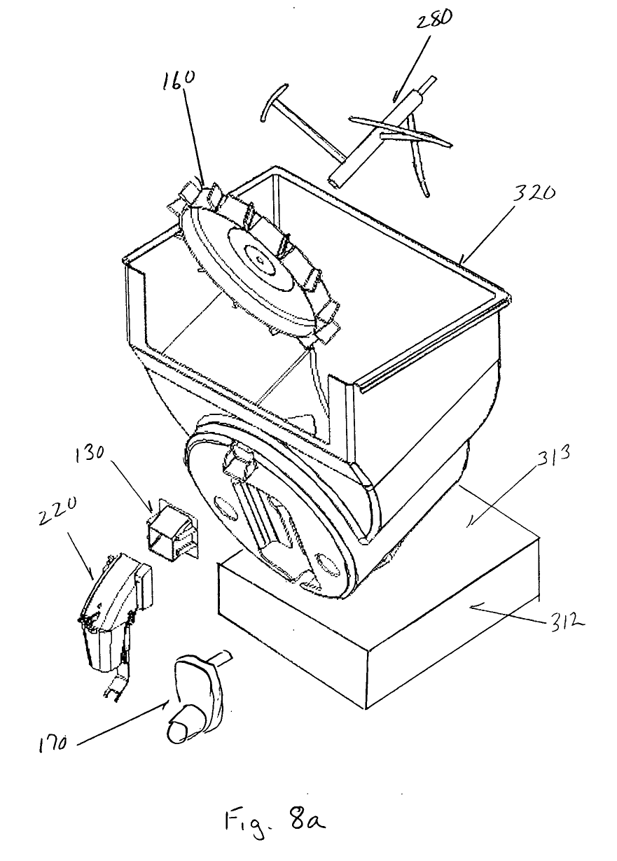

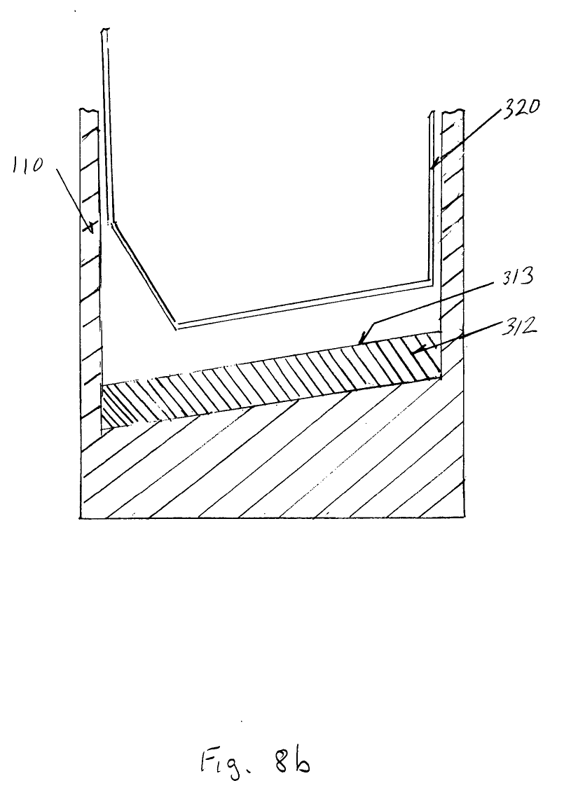

As shown in FIG. 8, an integrated dispenser 300 includes a beverage dispensing circuit 305 and a compressed ice dispensing circuit 306. The beverage dispensing circuit 305 may include a dispensing valve 310, a cold plate 312, and connections suitable for delivering chilled fluids from tubes disposed within the cold plate 312 to the dispensing valves 310 for consumption. The dispensing valves 310 may further include activators 311 for use as an interface to consumers. One of ordinary skill in the art will recognize that the activators 311 may be electronic switches, levers, or the like. As shown in FIGS. 8a and 8b, this fourth embodiment provides for an upper surface 313 of the cold plate 312 to serve as a bottom of the interior cavity 111. The cold plate 312 further includes a draining feature connectable to the drain tube 117.

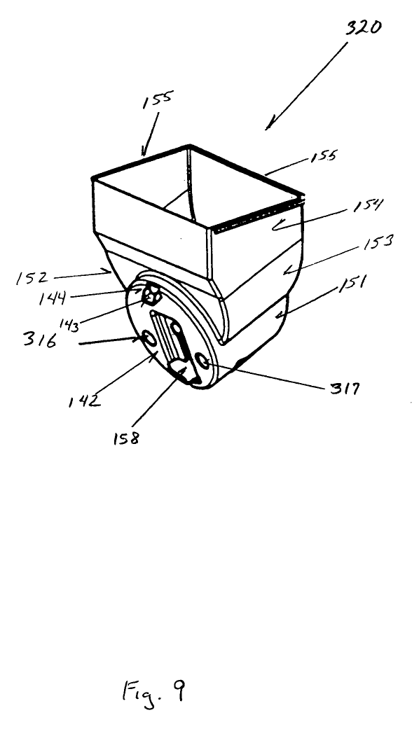

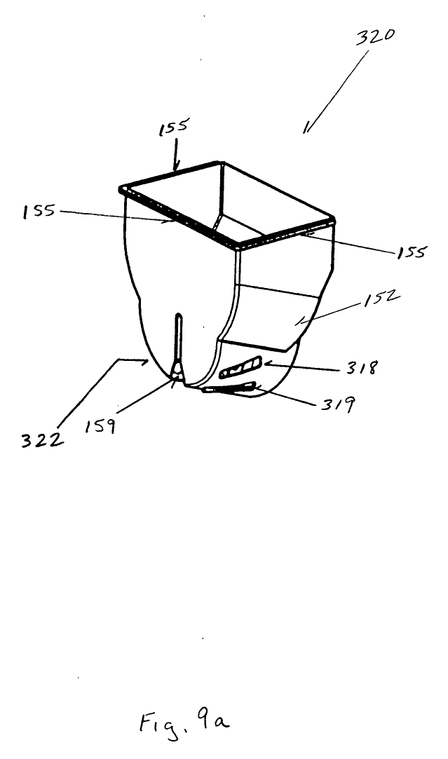

The ice dispensing circuit 306 is substantially identical to the ice dispensing circuit of the first embodiment, however, the fourth embodiment includes a shroud 320. The shroud 320 is substantially identical in shape to the shroud 150; however, the shroud 320 further includes recharge apertures. As shown in FIGS. 8a-9a, the shroud 320 includes a first front recharge aperture 316, a second front recharge aperture 317, an upper left recharge aperture 318, a lower left recharge aperture 319, and a lower right recharge aperture 322. The recharge apertures 316, 317, 318, 319, and 322 permit the passage of compressed ice from the storage chamber 147 to the upper surface 313 of the cold plate 312. One of ordinary skill in the art will recognize that at least one recharge aperture is required, but multiple recharge apertures may be employed to regulate the temperature of the cold plate 312. One of ordinary skill in the art will further recognize that the sizes of the recharge apertures may be increased or decreased to further adjust the amount of compressed ice delivered to the upper surface 313 of the cold plate 312.

On assembly, the cold plate 312 is suitably connected to the interior cavity 111, and the upper surface 313 of the cold plate 312 forms the bottom of the interior cavity 111. The shroud 320 is disposed within the interior cavity 111 as in the first embodiment. The installations of the paddlewheel 160, the agitator motor assembly 170, the ice chute assembly 220, and the agitator bar assembly 180 are identical to the first embodiment.

Operation of the integrated dispenser 300 is substantially identical to the operation of the first embodiment; however, the use of the shroud 320 in combination with the agitator bar assembly 180, and the cold plate 312 provides a recharging capability to the cold plate 312. As compressed ice fills the storage chamber 147, some compressed ice falls through the recharge apertures 316, 317, 318, 319, and 322 to provide cooling to the cold plate 312. The compressed ice that passes through the recharge apertures 316, 317, 318, 319, and 322 lands on the upper surface 313 of the cold plate 312, thereby chilling the cold plate 312. The distribution of the recharge apertures 316, 317, 318, 319, and 322 about the various areas of the cold plate 312 provides an optimum recharging effect on the cold plate 312. The cold plate 312 may further be recharged by passing compressed ice through shaft relief 158 and the rear relief 159.

In this fourth embodiment, the cold plate 312 is further recharged as the agitator bar assembly 180 is rotated. As the recharge apertures 318, 319, and 322 are located on the cylindrical section 151, a predetermined amount of compressed ice is pushed through the recharge apertures 318, 319, and 322 to the cold plate 312 when the agitator bar assembly 180 passes over the recharge apertures 318, 319, and 322. One of ordinary skill in the art will recognize that the length of the shoes 187, 189, and 195 of the agitator bar assembly 180 may vary with differing products or desired cold plate 312 temperatures. As compressed ice has an increased melt rate, optimum quantities of recharge compressed ice must be delivered to the cold plate 312, otherwise an unsatisfactory beverage drink temperature may be dispensed. The melted ice then flows through the drain tube 117 to the drip tray 108 or a suitable disposal conduit.

Operation of the beverage dispensing circuit 305 is well known in the art, wherein a concentrate flows through the cold plate 312 to the dispensing valve 310 where it may be mixed with a diluent when activated by a consumer.

Use of the ice dispensing circuit 306 is identical to the first embodiment, and includes compressed ice being delivered from the storage chamber 147 to an operator's cup as disclosed in FIG. 7. However, operators using this fourth embodiment may now acquire a predetermined amount of compressed ice, and a beverage drink within an acceptable temperature range at the integrated dispenser 300.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

We claim:

1. A dispenser adapted to dispense compressed ice, comprising:
a shroud including a storage chamber in communication with a dispensing port; and
a paddlewheel disposed within the storage chamber, the paddlewheel including a body having a leading edge and tangs disposed about an outer periphery of the body, wherein a leading edge of the tangs extends from within one half of an inch up to a leading edge of the body, and further wherein, the leading edges of the paddlewheel body are adjacent to an inner face of the storage chamber to capture compressed ice particles with the tangs when the paddlewheel is rotated, thereby delivering compressed ice stored in the storage chamber to the dispensing port.

2. The compressed ice dispenser according to claim 1, further comprising:
at least one beverage dispensing circuit for the delivery of a beverage or beverage concentrate from a beverage source to a dispensing valve for dispensing into an operator's cup.

3. The compressed ice dispenser according to claim 2, further comprising:
at least one diluent delivery circuit for the delivery of a diluent from a diluent source to the dispensing valve for mixing with the beverage or beverage concentrate.

4. The compressed ice dispenser according to claim 1, wherein the shroud comprises a cylindrical inset having a cylindrical face in communication with the dispensing port, and further wherein, the paddlewheel is located within the cylindrical inset such that the leading edges of the paddlewheel body are adjacent to the cylindrical face of the cylindrical inset to deliver compressed ice in the storage chamber to the dispensing port when the paddlewheel is rotated.

5. The compressed ice dispenser according to claim 4, wherein the cylindrical inset further comprises an inner perimeter, and further wherein, the peripheral leading edges of the paddlewheel tangs extend from within one half of an inch up to the inner perimeter.

6. The compressed ice dispenser according to claim 1, wherein the shroud includes a paddlewheel boss that prevents ice from packing beneath the body of the paddlewheel.

7. The compressed ice dispenser according to claim 4, wherein the cylindrical inset includes a paddlewheel boss that prevents compressed ice from packing beneath the body of the paddlewheel.

8. The compressed ice dispenser according to claim 1, wherein the paddlewheel includes a solid body to prevent compressed ice particles from packing between the body of the paddlewheel and the shroud.

9. The compressed ice dispenser according to claim 4, wherein the paddlewheel includes a solid body to prevent compressed ice particles from packing between the body of the paddlewheel and the shroud.

10. The compressed ice dispenser according to claim 2, further comprising:
a cold plate disposed beneath the shroud, wherein the compressed ice cools the cold plate, and further wherein, the at least one beverage dispensing circuit passes through the cold plate for cooling.

11. The compressed ice dispenser according to claim 1, further comprising:
an ice chute assembly disposed exterior to the shroud, the ice chute assembly including an inlet and an outlet, the inlet in communication with the dispense port on the shroud, wherein a floor of the ice chute assembly is curved to create an increasing vertical gravitational component as the ice to be dispensed moves along the floor to the outlet for dispensing.

12. The compressed ice dispenser according to claim 11, wherein the floor of the ice chute assembly curves downward.

13. The compressed ice dispenser according to claim 11, wherein the compressed ice flow path forms an arc as it moves from the inlet to the outlet.

14. The compressed ice dispenser according to claim 11, wherein the ice flow path includes an increasing head height to eliminate potential clogging of the ice chute assembly.

15. The compressed ice dispenser according to claim 13, wherein the arc of the floor is continuous.

16. The compressed ice dispenser according to claim 11, wherein the compressed ice entering the ice chute assembly fully evacuates the ice chute assembly to prevent packing in the compressed ice flow path.

17. The compressed ice dispenser according to claim 11, further comprising:
a chute in communication with the dispensing port and the inlet of the ice chute assembly, wherein the chute is angled downward to aid the movement of compressed ice from the dispensing port to the ice chute assembly.

18. The compressed ice dispenser according to claim 10, wherein the shroud further comprises at least one recharge aperture above the cold plate to allow the passage of compressed ice from the storage chamber to an upper surface of the cold plate to cool the cold plate.

19. The compressed ice dispenser according to claim 18, further comprising:
an agitator bar assembly coupled to the paddlewheel, wherein the agitator bar rotates with the paddle wheel to agitate the compressed ice stored in the storage chamber, and further wherein, the agitator bar forces a predetermined portion of compressed ice through the at least one recharge aperture when the agitator bar assembly is rotated.

20. The compressed ice dispenser according to claim 19, wherein the agitator bar assembly further comprises shoes disposed at a radial distance about the agitator bar assembly, and further wherein, at least one shoe passes over the at least one recharge aperture to force compressed ice through the at least one recharge aperture.

21. The compressed ice dispenser according to claim 20, wherein the shoes are aligned in a helical pattern to maximize a sweep area within the storage chamber.

22. The compressed ice dispenser according to claim 21, wherein the agitators are disposed within a range from thirty degrees to 40 degrees from the plane perpendicular to a shaft axis.

23. The compressed ice dispenser according to claim 22, wherein the shoes are disposed in the range from zero inches to one inch from an inner surface of the shroud.

24. A method of dispensing compressed ice, comprising:
a. storing compressed ice within a storage chamber of a shroud, the shroud including a dispensing port in communication with the storage chamber;
b. placing a paddlewheel including tangs into the storage chamber, wherein leading edges of the paddlewheel body are disposed adjacent to an inner face, and the leading edges of the tangs are disposed from within one half of an inch up to an inner face of the shroud to capture compressed ice; and
c. rotating the paddlewheel disposed within the storage chamber to segment portions of the compressed ice and move the segmented portions to the dispensing port for delivery.

25. The method according to claim 24, further comprising:
d. delivering the segmented portions of the compressed ice from the dispensing port to an outlet of a compressed ice flow path in an ice chute assembly, wherein the ice flowpath curves downward; and
e. evacuating the compressed ice flow path by moving the compressed ice to a portion of the compressed ice flow path having an increasing head height, such that the compressed ice falls to an outlet of the ice chute assembly for use.

26. A method of maintaining a desired drink temperature in an integrated beverage dispenser, comprising:
a. storing compressed ice within a storage chamber of a shroud disposed above a cold plate, the shroud including recharge apertures; and
b. moving compressed ice from the storage chamber through the recharge apertures to an upper surface of the cold plate to chill the cold plate.

27. The method according to claim 26, wherein step b. is replaced with
b. sweeping a shoe of an agitator bar along the profile of the inner surface of the shroud and over a recharge aperture at a distance in the range of zero inches to one inch to force a portion of the compressed ice through a respective recharge aperture; and
c. delivering a drink created from a product chilled by passing through the cold plate.

28. The method according to claim 27, further comprising:
d. repeating steps a. through c. to maintain the temperature of the cold plate, thereby maintaining a predetermined drink temperature.
